(19) United States
(12) Patent Application Publication
(10) Pub. No.: US 2009/0263118 A1
(43) Pub. Date: Oct. 22, 2009

(54) Camera-mounting head with balance control

(76) Inventor: Thomas L. McKay, Austin, TX (US)

Correspondence Address: JACOBSON HOLMAN PLLC, 400 SEVENTH STREET N.W., SUITE 600, WASHINGTON, DC, 20004, US

(21) Appl. No.: 12/384,492

(22) Filed: Aug. 21, 2008

Related U.S. Application Data
(63) Continuation-in-part of application No. 29/300,564, filed on Apr. 10, 2008, now Pat. No. D594499.

(51) Int. Cl. G03B 17/00

(52) U.S. Cl. 396/421

(57) ABSTRACT

A head for mounting a camera on a tripod or jib includes an elongated base plate mountable on a tripod or a jib for a panning motion, a support column extending vertically from the top surface of the base plate, a carrier arm having a longitudinal axis extending between its first and second ends and being pivotably mounted at its first end to the top of the support column, a camera platform movably mounted on the carrier arm, and a pan and tilt handle operatively connected to the camera platform for tilting the camera platform. The position of the camera platform is adjustable along the axis of the carrier arm. The camera platform is configured to allow adjustment of the camera's position thereon for balancing the camera's center of gravity.

### CROSS-REFERENCE TO RELATED APPLICATIONS

The present patent application is a continuation-in-part of application Ser. No. 29/300,564, filed Apr. 10, 2008, which is incorporated herein by reference in its entirety; and is related to Application Attorney Docket No. P72572US2, entitled “DESIGN FOR A TRIPOD HEAD,” filed concurrently herewith, and which is also incorporated herein by reference in its entirety.

### COPYRIGHTED MATERIAL

Not applicable.

### BACKGROUND OF THE INVENTION

1. Field of the Invention

The present invention relates to a head for mounting a camera on a tripod or jib. More specifically, the invention relates to such a head, which a camera operator can use to exactly balance the camera's center of gravity.

2. Related Art

U.S. Pat. Nos. 1,894,456, 2,514,313, 4,249,817, 4,621,785, 5,497,214, 5,725,187, 5,752,113, and 6,698,942 all disclose different types of heads for mounting cameras on tripods, and for pivoting and/or panning the mounted camera.

Although conventional tripod heads allow a user to pan and tilt a camera mounted thereon, they provide limited options for balancing the camera's center of gravity, and such options as they do provide prevent the user from adjusting the camera's pan and tilt without having to tighten the drag control.

It is to the solution of these and other problems that the present invention is directed.

### SUMMARY OF THE INVENTION

It is accordingly a primary object of the present invention to provide a head that can be used for mounting a cameral on either a tripod or a jib.

It is another object of the present invention to provide a tripod or jib-mounted head that allows a user to exactly balance the camera's center of gravity.

It is still another object of the present invention to provide a tripod or jib-mounted head that allows a user to exactly balance the camera's center of gravity so that the user can manually adjust the camera's pan and tilt to any position without having to tighten the head's drag control. It is still another object of the present invention to provide a tripod or jib-mounted head that allows a user to manually pan and tilt a camera without having to tighten the head's drag control with one hand while tilting the camera with the other hand.

These and other objects are achieved by a head for mounting a camera on a tripod or jib, which includes an elongated base plate mountable on a tripod or a jib for a panning motion, a support column extending vertically from the top surface of the base plate, a carrier arm having a longitudinal axis extending between its first and second ends and being pivotably mounted at its first end to the top of the support column, a camera platform movably mounted on the carrier arm, and a pan and tilt handle operatively connected to the camera platform for tilting the camera platform. The position of the camera platform is adjustable along the axis of the carrier arm. The camera platform is configured to allow adjustment of the camera's position thereon for balancing the camera's center of gravity. An auxiliary handle, which is movable between retracted and extended positions, is mounted on the base plate via a socket for pivoting the head relative to the tripod or jib when the camera is tilted with its lens directed either up or down.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a front perspective view showing the camera-mounting head with balance control, in accordance with the present invention, with the camera platform tilted in a horizontal plane.

FIG. 2 is a right side elevational view of the camera-mounting head of FIG. 1.

FIG. 3 is a front elevational view of the camera-mounting head of FIG. 1.

FIG. 4 is a left side elevational view of the camera-mounting head of FIG. 1.

FIG. 5 is a back elevational view of the camera-mounting head of FIG. 1.

FIG. 6 is a top plan view of the camera-mounting head of FIG. 1.

FIG. 7 is a bottom plan view of the camera-mounting head of FIG. 1.

FIG. 8 is a right side elevational view of the camera-mounting head of FIG. 1, with the camera platform tilted in a vertical plane.

FIGS. 9a-9c are back elevational views of the camera-mounting head of FIG. 1, showing a camera mounted on the camera platform, with the camera platform tilted in a vertical plane, a horizontal plane, and a plane at approximately 45° to the horizontal, respectively.

FIGS. 10a-10d are bottom plan views of the camera-mounting head of FIG. 1, with the base plate shown partially broken away, illustrating the panning motion of the camera-mounting head in the direction of the arrows.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

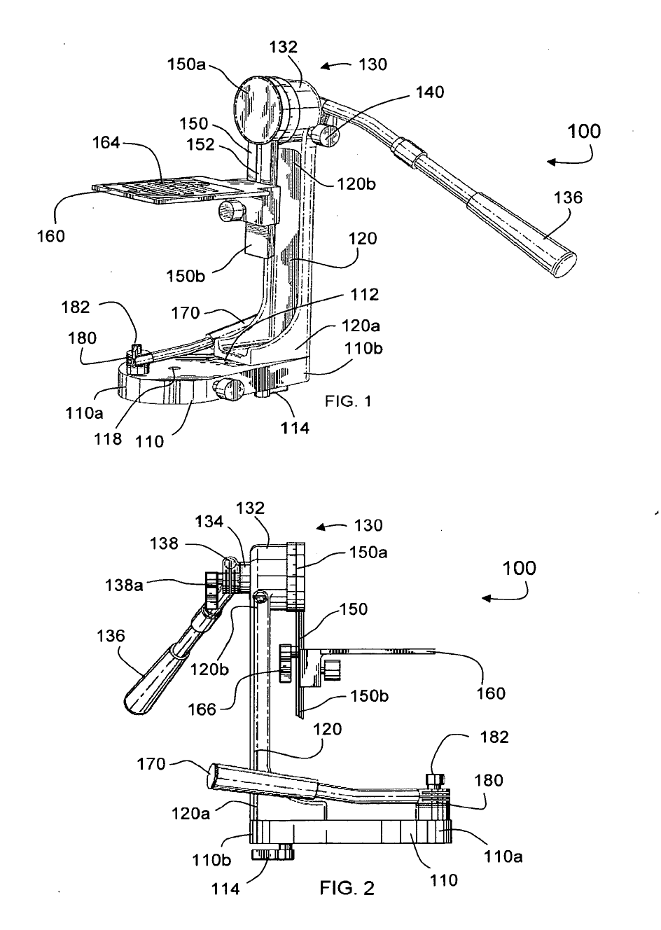

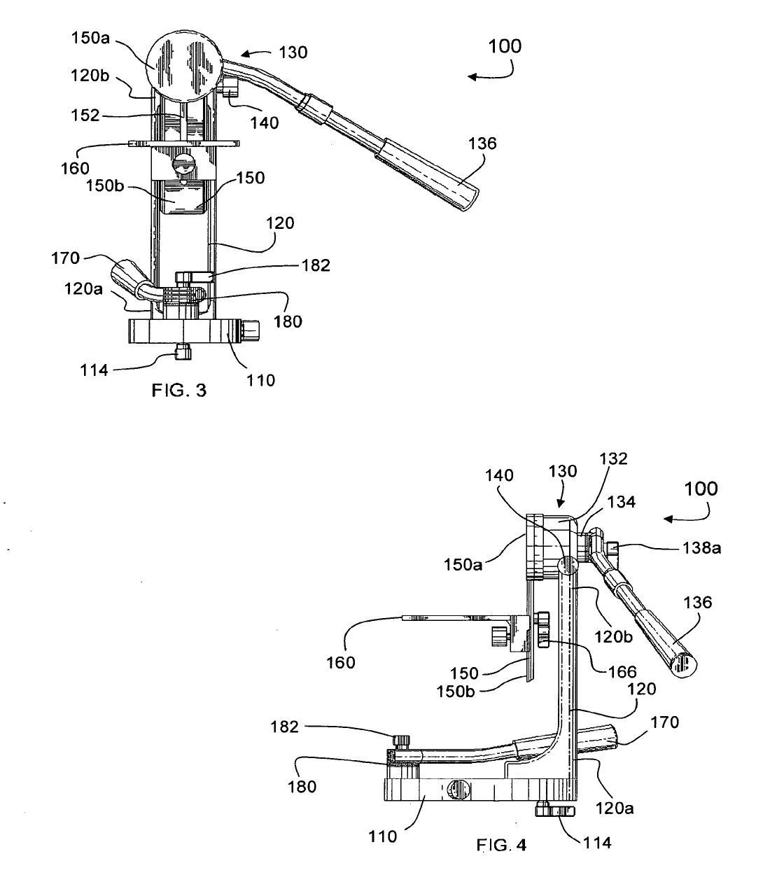

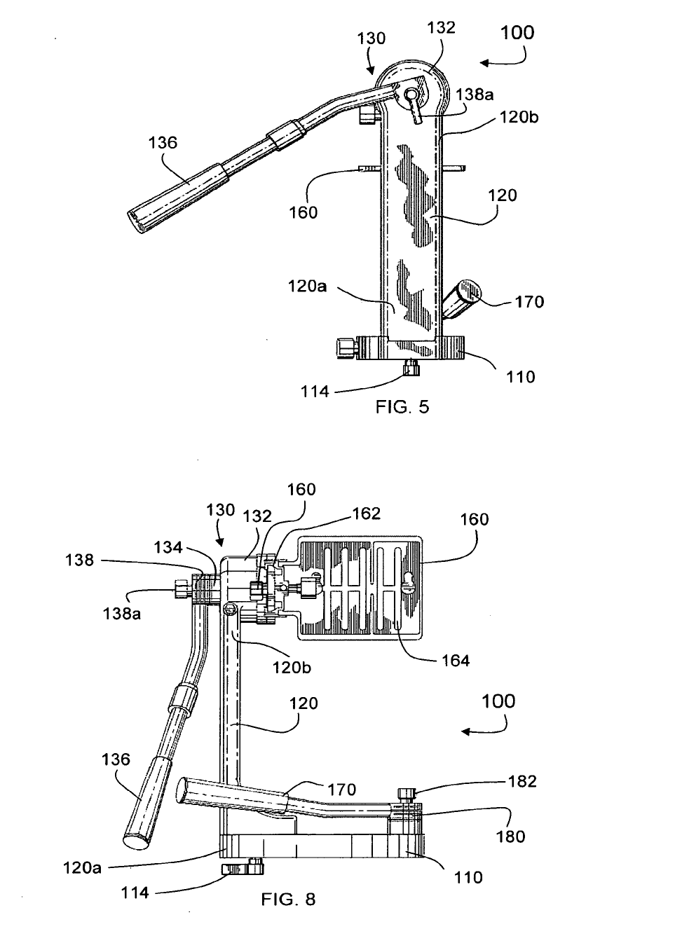

Referring now to FIGS. 1-8, a camera-mounting head 100 in accordance with the present invention, for mounting a camera 10 on a tripod or jib (not shown), comprises an elongated base plate 110 having first and second ends 110a and 110b and a support column 120 extending vertically from the top surface of the base plate 110 at the second end 110b, the support column 120 having a first end 120a attached to the base plate 110 and a second end 120b remote from the base plate 110. The base plate 110 can be provided with a level 118, for example set into its top surface, for use in aligning the head 100 relative to a horizontal plane. A tripod or jib mount (not shown) can be attached to the bottom surface of the base plate 110 at the front end for pivotably mounting the head 100 to a tripod or a jib.

A conventional pan and tilt handle unit 130 (for example, as disclosed in U.S. Pat. No. 2,514,313 to Davidson et al. or as taught in U.S. Pat. No. 4,621,785 to Embra) is provided at the free end 120a of the support column 120. A carrier arm 150 having first and second ends 150a and 150b is fixedly mounted to the pan and tilt handle unit 130 at its first end 150a, as discussed in greater detail hereinafter; and a camera platform 160 is movably mounted on the carrier arm 150. An auxiliary handle 170 is provided on the base plate 110 for pivoting the head 100 relative to the tripod or jib when the camera is tilted with its lens directed either up or down, as will be described in greater detail hereinafter.

The pan and tilt handle unit 130 includes a stationary tilt casing 132 on the free end of the support column 120, a tilt shaft 134 rotatable in the tilt casing 132 a, a pan and tilt handle 136 removably attached to a first end of the tilt shaft 134 via a pan and tilt handle socket 138, and a socket lever 138 for selectively locking the pan and tilt handle 136 in the pan and tilt handle socket 138. The tilt casing 132 can be formed unitarily with the support column 120 as best shown in FIGS. 1, 2, 4, 5, 8, and 9a-9c, or can be a separate piece attached to the free end of the support column 120. A conventional locking drag control 140 is provided in the tilt casing 132 for adjusting the tilting drag and locking the tilt shaft 134.

The pan and tilt handle 136, pan and tilt handle socket 138, and socket lever 138 can be conventional, as taught in U.S. Pat. No. 4,621,785, the disclosure of which is incorporated herein by reference. In such a construction, when the socket lever 138 is partially loosened, the tilt socket 138 can be rotated around the tilt shaft 134, in order to adjust the position of the pan and tilt handle 136 relative to axis of the tilt shaft 134.

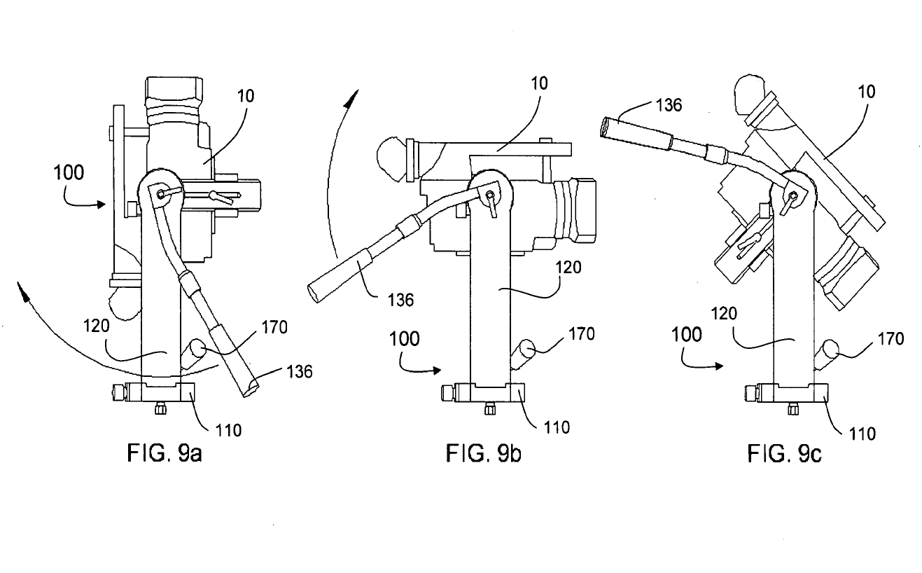

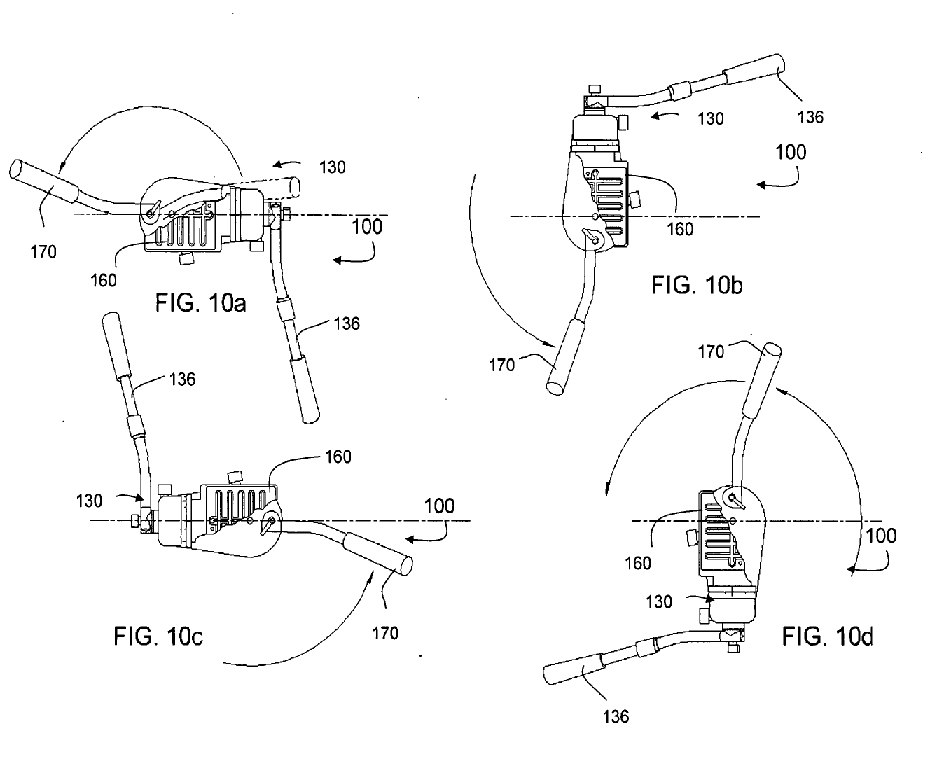

The carrier arm 150 is fixedly mounted at its first end to the second end of the tilt shaft 134 for movement with the tilt shaft 134. In other words, the pan and tilt handle 136 is operatively connected to the camera platform 160 via the carrier arm 150 and the tilt shaft 134 for tilting the camera platform 160 in a circular path around a horizontal axis, as shown in FIGS. 9a-9c. The pan and tilt handle 136 also is operatively connected to the base plate 110 via the support column 120 for panning the head 100 on the tripod or jib mount around a vertical axis, as shown in FIGS. 10a-10d. The carrier arm 150 is oriented relative to the tilt shaft 134 such that the plane of rotation of the carrier arm 150 is perpendicular to the rotation axis of the tilt shaft 134.

An auxiliary handle socket 180 with a conventional locking lever or knob 182 (for example, as disclosed with respect to the pan handle arrangement of U.S. Pat. No. 4,621,785) can be affixed to the top surface of the base plate 110 for removably attaching the auxiliary handle 170 to the base plate 110, and for selectively pivoting the auxiliary handle 170 around an axis perpendicular to the base plate 110, between a retracted position in which it rests over the base plate 110 (as shown in FIGS. 1-8, and 9a-9c) and an extended position in which it extends outwardly from the base plate 110 (as shown in FIGS. 10a-10d). When camera platform 160 is positioned vertically or nearly vertically with the camera 10 aimed up (as shown in FIG. 9a) or down, the auxiliary handle 170 can be moved by the camera operator into the extended position to more easily pivot the head 100 on the tripod or jib mount. The auxiliary handle 170 can conveniently be moved to its retracted position when not being used by the camera operator. The auxiliary handle 170 also can be removed from the auxiliary handle socket 180 by fully loosening the locking lever or knob 182.

A mechanism is provided for mounting the support column 120 to the base plate 110 in a manner that allows for selectively adjusting the position of the support column 120 along an axis between the first and second ends 110a and 110b of the base plate 110. For example, the base plate 110 can be provided with one or more slots or tracks 112 therein, and the first end 120a of the support column 120 can be configured for sliding engagement in the slots or tracks 112, with one or more knobs, spindle grips, or the like 114 for selectively locking the support column 120 in place relative to the base plate 110.

The camera platform 160 is mounted to the carrier arm 150 in a manner that allows the position of the camera platform 160 to be selectively adjusted along an axis between the first and second ends of the carrier arm 150. For example, the carrier arm 150 can be provided with an axial slot 152 extending inwardly from the second end 150b, and one end of the camera platform 160 can be provided with an internally threaded bore (not shown) for receiving the threaded shaft of a knob extending through the slot. Further, the camera platform 160 can be provided at its end with a groove 162 (FIG. 8) having a profile configured to matingly engage the sides of the carrier arm 150, to further stabilize the camera platform. However, as will be appreciated by those of skill in the art, any other mechanism can be used that allows for selective adjustment and stabilization of the position of the camera platform 160 on the carrier arm 150.

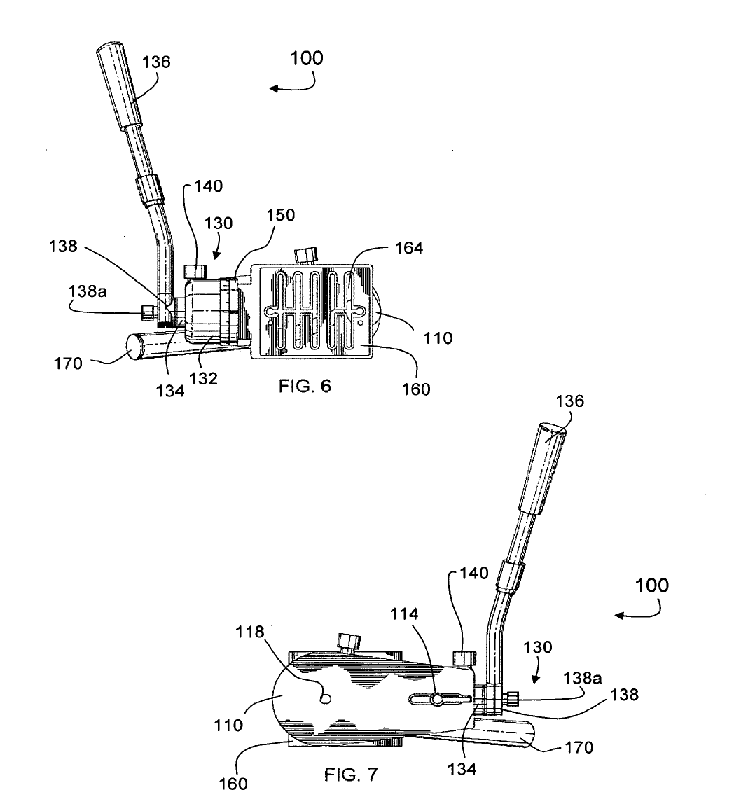

The camera platform 160 includes means for balancing the camera's center of gravity. Preferably, the balancing means comprises a plurality of slots or apertures in the camera platform 160, aligned and positioned to permit the camera to be attached to the camera platform 160 (via, for example, a conventional knob) at a point where its center of gravity is balanced. The slots or apertures can be separate, as shown in parent application Ser. No. 29/300,564,or interconnected as best shown in FIGS. 6 and 8, so that the position of the camera can be adjusted without having to disengage the knob from the camera.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A head for mounting a camera on a tripod or jib, comprising:
an elongated base plate having first and second ends;
a support column extending vertically from the top surface of the base plate at the second end of the base plate, the support column having a first end attached to the base plate and a second end remote from the base plate;
a carrier arm having first and second ends and a longitudinal axis extending between its first and second ends, the carrier arm being pivotably mounted at its first end to the top of the support column;
a camera platform movably mounted on the carrier arm, the position of the camera platform being adjustable along the axis of the carrier arm, the camera platform including means. for balancing the camera's center of gravity; and
a pan and tilt handle operatively connected to the camera platform for tilting the camera platform and for panning the head relative to the tripod or jib.

2. The head of claim 1, further comprising an auxiliary handle provided on the base plate for rotating the head relative to the tripod or jib.

3. The head of claim 2, further comprising means for mounting the auxiliary handle on the base plate for movement between a retracted position and an extended position.

4. The head of claim 1, further comprising means for mounting the support column to the base plate for selectively adjusting the position of the support column along an axis between the first and second ends of the base plate.

5. The head of claim 1, further comprising a shaft extends through a bore in the support column, and wherein the carrier arm and the pan and tilt handle are attached to opposite ends of the shaft, the shaft being rotatable in the support column and fixed relative to the first end of the carrier arm perpendicular thereto so that rotation of the shaft causes the carrier arm to pivot around the axis of the shaft in a plane perpendicular to the plane of the base plate.
